(19) United States
(12) Patent Application Publication
(10) Pub. No.: US 2008/0243386 A1
(43) Pub. Date: Oct. 2, 2008

(54) Method and System for Communicating Arrival Notifications

(75) Inventors: Sanjeev Kumar, San Jose, CA (US); Labhesh Patel, San Francisco, CA (US); Mukul Jain, San Jose, CA (US); Joseph F. Khouri, San Jose, CA (US)

Correspondence Address: BAKER BOTTS L.L.P., 2001 ROSS AVENUE, SUITE 600, DALLAS, TX, 75201-2980, US

(73) Assignee: Cisco Technology, Inc., San Jose, CA (US)

(21) Appl. No.: 11/691,891

(22) Filed: Mar. 27, 2007

(51) Int. Cl. G08B 1/00

(52) U.S. Cl. 701/300; 340/286.01; 340/313

(57) ABSTRACT

A method for communicating an arrival notification includes receiving a first destination and determining a location of the first destination. The method further includes calculating an estimated time of arrival for a mobile endpoint to arrive at the location of the first destination and sending a notification message indicating the estimated time of arrival to a communication device associated with the first destination.

### TECHNICAL FIELD

The present invention relates in general to communication systems and, more particularly, to a method and system for communicating arrival notifications.

### BACKGROUND

Customers often go to stores with the intention of purchasing specific items. Businesses, however, are typically unaware of a given customer's intended purchases prior to the customer arriving at the store. Further, businesses are generally not informed as to when the customer might arrive to purchase an intended item. Accordingly, businesses are typically unable to adequately prepare for a customer's arrival and therefore may not provide customers with an optimal level of service.

### SUMMARY

The present invention provides a method and system for communicating an arrival notification that substantially eliminates or greatly reduces at least some of the disadvantages and problems associated with previous methods and systems.

In accordance with one embodiment, a method for communicating an arrival notification includes receiving a first destination and determining a location of the first destination. The method further includes calculating an estimated time of arrival for a mobile endpoint to arrive at the location of the first destination and sending a notification message indicating the estimated time of arrival to a communication device associated with the first destination.

In a more particular embodiment, the method further includes receiving position information associated with the mobile endpoint and determining a position of the mobile endpoint. In certain embodiments the position information may include global positioning system (GPS) signals. Additionally, the method may include determining a change in the estimated time of arrival and sending an update message to a communication device associated with the first destination location which indicates the change in the estimated time of arrival.

A further embodiment provides a mobile endpoint for communicating an arrival notification. The mobile endpoint is operable to determine a location of a first destination, calculate an estimated time of arrival for the mobile endpoint to reach the location, and send a notification message to a communication device associated with the first destination.

In some embodiments, the notification message may be anonymous with respect to an identity associated with the mobile endpoint. Alternatively, the notification message may identify the mobile endpoint or the user of the mobile endpoint. The notification message may also indicate an item which the user intends to purchase at the destination. In response to receiving the notification, a communication device at the destination may send a status message indicating the availability of the item, sale information or another location where the item intended to be purchased is available.

Technical advantages of certain embodiments include providing an ability to permit destinations such as stores to plan for customers who will be arriving. In particular, the destination may receive arrival notifications indicating an estimated time of arrival for the user to reach the destination. If the estimated time of arrival changes, the destination may be informed of the change by an update notification. Accordingly, a store or other destination may better serve customers by anticipating their arrival.

Other technical advantages will be readily apparent to one skilled in the art from the following figures, descriptions, and claims. Moreover, while specific advantages have been enumerated above, various embodiments may include all, some or none of the enumerated advantages.

### BRIEF DESCRIPTION OF THE DRAWINGS

For a more complete understanding of the present invention and its advantages, reference is now made to the following description, taken in conjunction with the accompanying drawings in which:

FIG. 1 is a simplified block diagram illustrating a communication system for communicating arrival notifications in accordance with a particular embodiment of the present invention;

FIG. 2 is a simplified block diagram illustrating an example mobile endpoint in accordance with a particular embodiment; and

FIG. 3 is a flow chart illustrating a method for communicating an arrival notification according to an embodiment of the present invention.

### DETAILED DESCRIPTION

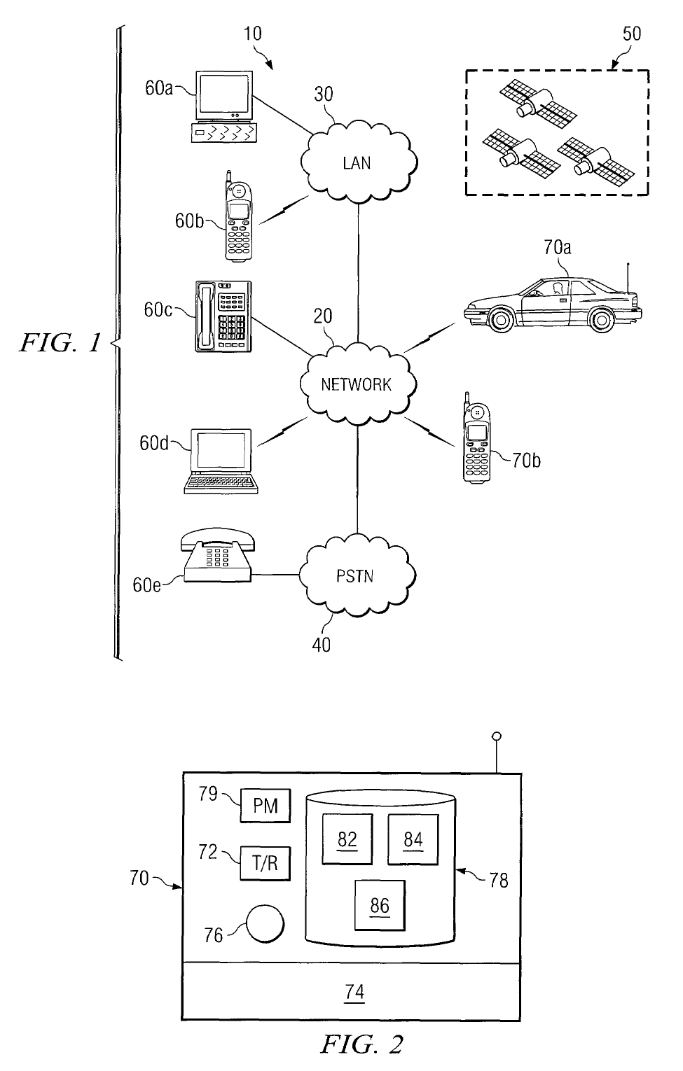

FIG. 1 illustrates a communication system 10 according to a particular embodiment. As illustrated, communication system 10 includes communication network 20, local area network (LAN) 30, public switched telephone network (PSTN) 40, positioning unit 50, and a plurality of communication devices 60a-60e and mobile endpoints 70a-70b. In particular embodiments, mobile endpoints 70a-70b are devices capable of communicating with communication devices 60a-60e and positioning unit 50. As discussed in further detail below, positioning unit 50 provides location information for certain mobile endpoints 70a-70b.

In accordance with particular embodiments, a user at a mobile endpoint may input a desired destination and, in response to receiving the destination, the mobile endpoint may determine an estimated time of arrival (ETA) for the mobile endpoint to reach the destination. The mobile endpoint may then transmit a message indicating the ETA to a communication device associated with the destination. In particular embodiments, the destination location may be a commercial enterprise such as a store, restaurant, or warehouse, that may respond to the message by making preparations for the user's arrival.

As illustrated in FIG. 1, communication network 20 represents any network capable of transmitting audio and/or video telecommunication signals, data, and/or messages, including signals, data, or messages transmitted through text chat, instant messaging, and e-mail. Accordingly, communication network 20 may comprise all, or a portion of, a radio access network; a public switched telephone network (PSTN); a public or private data network; a local area network (LAN); a metropolitan area network (MAN); a wide area network (WAN); a local, regional, or global communication or computer network such as the Internet; a wireline or wireless network; an enterprise intranet; or any combination of the preceding. To facilitate its communication capabilities, communication network 20 may include routers, hubs, switches, gateways, call controllers, and/or any other suitable components in any suitable form or arrangement. Additionally, communication network 20 may represent any hardware and/or software configured to communicate information in the form of packets, cells, frames, segments or other portions of data. Although communication network 20 is illustrated as a single network, communication network 20 may comprise any number or configuration of networks. Moreover, communication system 10 may include any number or configuration of communication networks 20.

Communications over communication network 20 may employ any suitable communication protocol. In particular embodiments, communication network 20 may use communication protocols that allow for the addressing or identification of endpoints, nodes, and/or other components coupled to the communication network. For example, using Internet protocol (IP), each of the components coupled together by communication network 10 may be identified in information directed using IP addresses. In this manner, communication network 20 may support any form and/or combination of point-to-point, multicast, unicast, or other techniques for exchanging media packets among components in communication system 10. Since IP networks share a common method of transmitting data, telecommunication signals may be transmitted between telephony devices located on different, but interconnected, IP networks. In addition to being coupled to other IP networks, communication network 20 may also be coupled to non-IP telecommunication networks, for example through the use of interfaces or components, including gateways.

In particular embodiments, communication network 20 may receive and transmit data in a session initiation protocol (SIP) environment. In such embodiments, particular communication devices 60 and mobile endpoints 70 may be SIP enabled devices. SIP is an application-layer control protocol that includes primitives for establishing, modifying, and terminating communication sessions. SIP works independently of underlying transport protocols and without dependency on the type of session that is being established. SIP also transparently supports name mapping and redirection services, which support personal mobility.

LAN 30 provides connectivity between components coupled to LAN 30 using any appropriate communication protocol. LAN 30 also couples such components to communication network 20 to provide connectivity with devices coupled to communication network 20. LAN 30 may represent any hardware and/or software configured to communicate information in the form of packets, cells, frames, segments or other portions of data. Additionally, LAN 30 may include routers, hubs, switches, gateways, call controllers, and/or any other suitable components in any suitable form or arrangement. In particular embodiments, LAN 30 represents all or a portion of an Ethernet network connecting communication devices 60 of a particular entity, such as a company, store, warehouse, and/or other business entity.

PSTN 40 includes switching stations, central offices, mobile telephone switching offices, pager switching offices, remote terminals, and other related telecommunications equipment that may be located throughout the world. PSTN 40 may interface with communication network 20 through a gateway to provide interoperable communication between communication device 60e coupled to PSTN 40 and other devices within communication system 10.

Positioning unit 50 represents hardware and software, including appropriate controlling logic, capable of providing position information related to the location of a mobile endpoint 70. For example, as illustrated, positioning unit 50 represents a plurality of satellites in a global navigation satellite system such as the global positioning system (GPS). Alternatively, positioning unit 50 may represent a differential GPS (DGPS) system. Accordingly, positioning unit 50 may comprise a network of fixed ground based reference stations operable to broadcast differences between positions identified by a satellite and known fixed positions. In the illustrated embodiment, positioning unit 50 may communicate with a receiver in mobile endpoint 70 using any suitable communications protocol. Additionally, communications with mobile endpoint 70 may occur directly, or indirectly through communication network 20.

Communication devices 60a-60e (“communication devices 60”) may represent any suitable combination of hardware, software, and/or encoded logic to provide communication services to a user. For example, communication devices 60 may represent PSTN telephones; IP phones; cell phones; computers running telephony, e-mail, or other forms of messaging and/or communication software; video monitors; cameras; or any other communication hardware, software, and/or encoded logic that supports communication of voice, video, text or other suitable forms of data using communication system 10. Communication devices 60 may connect to a communication network, such as communication network 20 or LAN 30, in numerous ways. For instance, a connection might be made through a fixed broadband connection such as a digital subscriber line (DSL), cable modem, or Ethernet. Wireless access to communication network 22 may be initiated through a WLAN, WiMAX, or WiFi access point. Further, mobile access may be permitted via code division multiple access (CDMA), CDMA2000, general packet radio service (GPRS), universal mobile telecommunications system (UMTS), evolution-data optimized (EV-DO), and/or any other suitable mobile standard. While FIG. 1 illustrates a particular number and configuration of communication devices 60, communication system 10 contemplates any number or arrangement of such components to support communication of media.

Mobile endpoints 70a-70b (“mobile endpoints 70”) facilitate interaction between users of communication system 10 and positioning unit 50. In an embodiment, mobile endpoints 70 are operable to receive position information from positioning unit 50, calculate an estimated time of arrival at a location, and communicate this information to a communication device 60 associated with the location. In addition to determining its own location, a mobile endpoint 70 may also determine the location of a destination. Examples of mobile endpoints 70 may include, but are not limited to, mobile phones, personal digital assistant (PDAs), automotive navigation systems, and/or personal computers (PCs). In general, however, each mobile endpoint 70 may represent any appropriate collection of hardware and/or software suitable to provide the described functionality.

Mobile endpoints 70 may communicate with communication network 20 and/or positioning unit 50 using any suitable mobile or wireless communication standard. For example, mobile endpoints may connect to communication network 20 using any of the mobile or wireless standards discussed with respect to communication devices 60. Additionally, to facilitate the described communication capabilities, each mobile endpoint 70 may have a display such as a graphical user interface (GUI), video and/or voice user interface (VUI), or a textual user interface (TUI), to present suitable information to a user. While FIG. 1 illustrates a particular number and configuration of mobile endpoints 70, communication system 10 contemplates any number or arrangement of such components.

In a particular embodiment, mobile endpoints 70 may include or have access to a map database 82 (shown in FIG. 2). The map database may maintain and store locations such as streets, business addresses, house numbers, and or any other place of interest. The locations may be encoded as geographic coordinates such that mobile endpoint 70 may determine its position relative to a destination input by a user at mobile endpoint 70. For example, if a user at a mobile endpoint 70 inputs a destination location, mobile endpoint 70 may calculate a distance to the destination location from its current location using the stored map. Further, map database 82 may allow mobile endpoint 70 to provide the user with information such as driving directions or a best route to the destination. In certain embodiments, the directions may be presented on a user interface.

In operation, mobile endpoints 70 may use position information obtained from positioning unit 50 to calculate its respective position. In the illustrated embodiment, mobile endpoint 70 includes a GPS receiver and may calculate its position by trilateration. More specifically, the position of a mobile endpoint 70 may be determined by measuring the distance between the mobile endpoint 70 and three or more GPS satellites of positioning unit 50 each having known positions. Because GPS signals travel at a known speed, the distance between a mobile endpoint 70 and a satellite of positioning unit 50 may be established by measuring the time delay between transmission and reception of a GPS signal. The position of each satellite may be communicated in the GPS signal transmitted from the satellite. Once the distances from three satellites, including their locations, are known, the position of a mobile endpoint 70 may be determined. In a particular embodiment, mobile endpoint 70 may calculate its position in terms of longitudinal and latitudinal coordinates. Although, a specific method for determining the position of a mobile endpoint 70 has been described in detail, other ways to determine a position of a mobile endpoint may be used in various embodiments.

Mobile endpoints 70 may also identify future locations of the device from a current location. In particular, mobile endpoints 70 may employ dead reckoning to determine future locations. Dead reckoning is a process of estimating a current position based on a previously identified or fixed location, and extrapolating future locations using data such as velocity, time, and direction of movement. Velocity and direction of movement may be calculated using changes and/or updates in the position information received from positioning unit 50. For example, if the mobile endpoint 70 determines its location at each of a first and a second time, a velocity and direction of movement may be calculated by analyzing the change in the position of the mobile endpoint over the elapsed time period. Alternatively, in a particular embodiment, mobile endpoint 70 may communicate with sensors affixed to a drivetrain of an automobile as well as a gyroscope. The gyroscope may provide mobile endpoint 70 with directional data while the drivetrain sensors may measure the velocity of the automobile. In certain embodiments, mobile endpoints 70 may combine and/or update the predicted location whenever new position information is received from positioning unit 50.

In accordance with an embodiment, mobile endpoints 70 may further determine an ETA to reach a destination. The ETA may be determined based on a stored list of times, historical data, or through a multitude of calculative techniques. For instance, mobile endpoint 70 may use position information from positioning unit 50, a stored map, as well as the velocity and direction data to calculate a specific ETA. To enhance accuracy, mobile endpoints 70 may also use other variables in the ETA calculation including, but not limited to, traffic, time of day, speed limits, construction, and weather. The ETA may be updated by mobile endpoint 70 in response to changes in any of variables used in calculating the ETA.

FIG. 1 illustrates the general interaction of the components of communication system 10 in accordance with a particular embodiment. In this example, a user at a mobile endpoint 70 may input a destination such as a store, restaurant, warehouse, or general address. Mobile endpoint 70 may then determine the location of the destination relative to its current location using position information received from positioning device 50 and the map database. Additionally, mobile endpoint 70 may calculate an ETA to reach the destination and communicate the ETA in a notification message to a communication device 60 associated with the destination. Mobile endpoint 70 may continually update the ETA, and in response to changes in the ETA, it may send an update message indicating the new ETA. Similarly, if the user changes the destination location by typing a different address or selecting a different location as the destination, then the mobile endpoint may send a message indicating the change to the previous destination as well as to the new destination. In certain embodiments the user may specify when an ETA update message is sent. In other embodiments a service provider may designate when an update message should be sent.

To further illustrate the features of the present invention, the following example is provided wherein the destination location is a retail store. Upon the entry into mobile endpoint 70 of a store as the destination, mobile endpoint 70 may prompt the user to specify the item(s) that the user wants to purchase from the store. Mobile endpoint 70 may then send a notification to a communication device 60 associated with the store indicating the user's ETA and/or the items which the user desires to purchase. This enables the store to ensure that sufficient quantities of the specified item(s) are available when the user arrives. If one or more of the entered items is not in stock, then a communication device 60 associated with the store may send a status message to mobile endpoint 70 indicating that the item(s) is not available. The status message may also indicate a counterpart store (i.e. one associated with the original destination) where the item(s) is available for purchase. Alternatively, the status message may include information such as a coupon code, whether the item(s) is on sale, when the item(s) will go on sale, or when a currently unavailable item will become available. By contrast, if the item is available, the communication device 60 associated with the store may send a status message indicating that the item is available. Additionally, if the item is available, mobile endpoint 70 may query the user as to whether the user would like to reserve and/or pre-purchase the item. If the user decides to reserve or pre-purchase the item, mobile endpoint 70 may send a reserve request to the store.

In a particular embodiment, a notification message may also be sent to alternate destinations. An alternate destination may be a competing enterprise such as a store that sells similar items as those entered by the user; a comparable restaurant to one entered by the user; and/or a business in the same market, field, or industry as a business entered by the user. To illustrate, if a user inputs an appliance store as the destination, then mobile endpoint 70 may send a notification message to a competing appliance store so that it may make the user a counter proposal. The counter proposal may be indicated in a status message from the competing appliance store. In an embodiment, mobile endpoint 70 may prompt the user with a list of alternate destinations. If the user accepts one of the alternate destinations, then mobile endpoint 70 may provide the user with a new set of directions and send a notification message to the new destination. In addition, mobile endpoint 70 may provide the user with a phone number or other contact information associated with either the original destination and/or the alternate destination so that the user may contact the destination before arrival. To maximize potential revenue streams, the service provider may charge/bill the alternate destination for providing information to a user at mobile endpoint 70.

In another embodiment, a user may directly input a particular product which the user intends to purchase into mobile endpoint 70. Upon the entry of the product, mobile endpoint 70 may communicate with a database to determine locations (i.e. stores) where the product may be purchased. The database may be accessible through communication network 20 or may be stored in a memory unit of mobile endpoint 70. In a further embodiment, the product may have an associated radio frequency identification (RFID) number. Thus, mobile endpoint 70 may use the RFID number when searching a database for locations where the product may be purchased. Mobile endpoint 70 may then send a request message to one or more locations which prompts the locations to provide the mobile endpoint with information regarding the availability of the product which match the user's query. In a particular embodiment, the request message may be sent to one or more stores selected by a user of mobile endpoint 70. In addition, the request message may include the RFID number associated with the product so that the stores may readily determine the availability of the product. In response to receiving the availability information, mobile endpoint 70 may present the information to the user and provide directions to the locations where the product is available.

While some embodiments have been described with functionality performed by mobile endpoint 70, other embodiments may include one or more components external to a mobile endpoint 70 having similar operability. In particular, a server or other processing unit may be coupled to a communication network, such as communication network 20 of FIG. 1. The server may be operable to perform any of the functionality described as performed by mobile endpoint 70. In particular, the server may receive information from mobile endpoint 70 or another component such as a satellite component in order to monitor the location of a mobile endpoint 70, execute the recited ETA calculations, and otherwise communicate information between a communication device 60 associated with a destination location, a mobile endpoint 70, and positioning unit 50. The server may be further operable to provide at least some of the functionality for multiple mobile endpoints 70.

With reference now to FIG. 2, the contents of a mobile endpoint 70 are illustrated in accordance with a particular embodiment. As shown, mobile endpoint 70 includes a transmitter/receiver 72, a user interface 74, a processor 76, a memory 78, and a positioning module 79.

In the illustrated embodiment, transmitter/receiver 72 may comprise an interface for receiving signals from positioning unit 50. More specifically, transmitter/receiver may be an interface representing hardware and software capable of obtaining position information from a GPS satellite. Transmitter/receiver 72 may also be an interface for receiving and transmitting communications such as audio, video, and other data to and from other network components including, but not limited to, communication devices 60. In certain embodiments, transmitter/receiver 72 may receive data regarding the velocity or direction of movement of mobile endpoint 70.

User interface 74 provides a mechanism through which a user at mobile endpoint 70 may operate the device and communicate with other network components. User interface 74 may include a keypad, display, touch screen, audio input or any other suitable interface. A user may submit instructions for mobile endpoint 70 via interface 74 in a multitude of ways such as through a collection of keystrokes, soft keys, and/or a speech recognition program such as an internal voice recognition (IVR) system. Additionally, user interface 74 may also include a GUI, TUI, or VUI.

Processor 76 may execute commands submitted by a user as well as other instructions associated with the services provided by mobile endpoint 70. Processor 76 may represent any suitable device(s) capable of processing and/or communicating electronic information. Examples of processor 76 include, but are not limited to, application-specific integrated circuits (ASICs), field-programmable gate arrays (FGPAs), digital signal processors (DSPs), and any other suitable specific or general purpose processors.

Memory 78 may store processor instructions and/or any other appropriate information used by mobile endpoint 70. Memory 78 may include any collection and arrangement of volatile or non-volatile, local or remote devices suitable for storing data. Examples of memory 78 include, but are not limited to, random access memory (RAM) devices, dynamic random access memory (DRAM), read only memory (ROM) devices, magnetic storage devices, optical storage devices, flash memory, or any other suitable data storage devices. In an embodiment, memory 78 maintains map database 82, position database 84, and preference database 86. Although, as illustrated, memory 78 includes particular data elements, it should be understood that memory 78 may maintain any suitable information for use in operation of mobile endpoint 70.

Map database 82 may include one or more maps for use in operation of mobile endpoint 70. In particular, map database may comprise any number of road maps or atlases. Additionally, map database 82 may maintain house numbers and other addresses. In certain embodiments map database 82 may store information regarding retail stores, businesses, restaurants, etc. Such information may include, phone number, address, line of business, and inventory data. Additionally, while map database 82 is illustrated as residing within memory 78 of mobile endpoint 70, map database 82 may be located anywhere within communication system 10 and may be accessible by mobile endpoint 70 via communication(s) with other components of communication system 10.

Position database 84 includes position information generated by positioning module 79 and stored for use by positioning module 79 or processor 78. The stored position information may be used by positioning module 79 to calculate the velocity and direction of movement of mobile endpoint 70 as well as changes in the ETA.

Preference database 86 includes one or more user preferences regarding the operation of mobile endpoint 70. For example, preference database 86 may include privacy settings regarding notification messages sent to communication devices 60. Such privacy settings may include whether the notification message is anonymous with respect to an identity associated with the mobile endpoint, and if not, what information the notification message may include. In certain embodiments, the user may selectively enable mobile endpoint to provide identifying information in the notification message. The identifying information may include a phone number, e-mail address, store account number, and/or credit card number. Preference database 86 may also include information regarding locations such as favorite businesses, preferred routes, and/or identifying information. Additionally, preference database 86 may include a specified interval for recalculating an ETA, as well as a threshold change in ETA before an ETA update message should be sent to a destination.

Positioning module 79 represents any suitable combination of hardware and/or controlling logic capable of determining the actual and/or future location of mobile endpoint 70. As represented in FIG. 2, positioning module 79 may calculate both the position of mobile endpoint 70 and an ETA for mobile endpoint 70 to reach a destination. Additionally, positioning module 79 may communicate with position database 84 to store position information and obtain prior position information for use in calculating an ETA.

In operation, positioning module 79 may analyze information received from positioning unit 50 and/or information stored in position database 84 to identify an actual location of mobile endpoint 70. The position of mobile endpoint 70 may be compared with a map stored in a map database 82 to determine the location of mobile endpoint 70 relative to a destination. Using velocity and direction information obtained from transmitter/receiver 72 and/or position information stored in position database 84, positioning module 79 may calculate an ETA for mobile endpoint 70 to reach the destination. Transmitter/receiver 72 may communicate the ETA in a notification message. The notification message may include identification information associated with the user and stored in preference database 86. It should be noted that the described interactions represent only one of many ways in which the components of a mobile endpoint 70 may provide it with its recited functionality.

While transmitter/receiver 72, processor 76, memory 78, and positioning module 79 have been described as components of a mobile endpoint 70, such components may be located anywhere within communication system 10 of FIG. 1. In particular, as mentioned, certain embodiments may include an external server coupled to network 20 of FIG. 1. Accordingly, the server may also include a transmitter/receiver 72, processor 76, memory 78, and positioning module 79 in addition to any other suitable components. Accordingly, the server may be operable to perform any of the functionality described with respect to mobile endpoint 70.

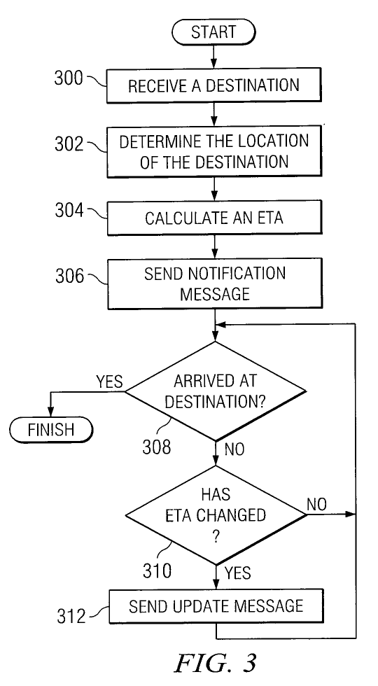

FIG. 3 illustrates a flowchart describing an example operation of a particular embodiment of mobile endpoint 70 in communicating an arrival notification. In the described embodiment, mobile endpoint 70 calculates an ETA and communicates the ETA to a communication device 60 associated with a destination.

The described process begins at step 300 with mobile endpoint 70 receiving a destination input by a user. The destination may be any location such as a residence or business. Additionally, the destination may be input by a user in any suitable manner such as by reference to the specific name of the business, general field of business (e.g. appliance store, super market, etc.), and/or address. In a particular embodiment where the destination is a retail store, mobile endpoint 70 may prompt the user to provide item(s) which the user wishes to purchase.

In response to receiving a destination, mobile endpoint 70 may determine the location of the destination at step 302. The location of the destination may be determined by searching a map database. Alternatively, mobile endpoint 70 may determine the location of the destination by communicating with the components of communication system 10 in any suitable manner.

After the location of the destination is known, mobile endpoint 70 may calculate an ETA for the device to reach the destination at step 304. The ETA may be calculated by comparing the location of the destination to the current position of mobile endpoint 70 and calculating a period of time that it will take the mobile endpoint 70 to reach the destination. The calculation may include variables such as velocity, direction of movement, and time. Additional variables which may be factored into the calculation include traffic flow, speed limits, time of day, etc.

After calculating the ETA, mobile endpoint 70 may, at step 306, send the ETA in a notification message to a communication device 60 associated with the destination. The notification message may be anonymous with respect to an identity associated with the mobile endpoint, or may contain certain identifying information if the user allows. In certain embodiments, the notification message may also include specified items for which the user has indicated an intention to purchase.

In certain embodiments, a communication device 60 associated with the destination may send a status message in response to receiving the notification message. The status message may include information such as whether a specified item is available. If the item is unavailable, the status message may contain information regarding when the item might become available or where the item is currently available for purchase. In certain embodiments the status message may include a coupon code or sale information.

At step 308 mobile endpoint 70 may determine whether it has arrived at the destination. If mobile endpoint 70 has not arrived at the destination, then it may, at step 310, determine whether the ETA has changed. If the change in ETA is greater than a threshold amount of time, mobile endpoint 70 may send an update message to the communication device 60 associated with the destination at step 312. The change in ETA that is necessary to trigger the sending of an update message may be designated by a user of mobile endpoint 70 and/or the service provider. If the ETA has not changed by the threshold amount, then mobile endpoint 70 may continue to monitor the ETA and return to step 308. The operation is complete when mobile endpoint 70 arrives at the destination.

One skilled in the art will readily recognize that some of the steps illustrated in FIG. 3 may be combined, modified or deleted where appropriate, and additional steps may also be added to the flowchart. Additionally, steps may be performed in any suitable order without departing from the scope of the invention.

Further, while the present invention has been described in detail with reference to particular embodiments, it should be understood that various other changes, substitutions, and alterations may be made hereto without departing from the spirit and scope of the present invention. For example, although particular embodiments have been described with reference to a number of elements included within a mobile endpoint, these elements may be combined, rearranged or positioned in order to accommodate particular needs. In addition, any of these elements may be provided as separate external components to a mobile endpoint where appropriate. For example, in some cases a determination of a location of a mobile endpoint may be performed by a separate device. Additionally, the ETA for a mobile endpoint 70 may be calculated by a separate component where appropriate. Particular embodiments contemplate great flexibility in the arrangement of these elements as well as their internal components and functions.

Numerous other changes, substitutions, variations, alterations and modifications may be ascertained by those skilled in the art and it is intended that the present invention encompass all such changes, substitutions, variations, alterations and modifications as falling within the spirit and scope of the appended claims.

What is claimed is:

1. A method for communicating an arrival notification, comprising:
receiving a first destination;
determining a location of the first destination;
calculating an estimated time of arrival, the estimated time of arrival indicating an estimated time for a mobile endpoint to arrive at the location of the first destination;
sending a notification message to a communication device associated with the first destination, the notification message indicating the estimated time of arrival.

2. The method of claim 1, further comprising:
receiving position information associated with the mobile endpoint; and
determining a position of the mobile endpoint from the position information.

3. The method of claim 2, wherein the position information comprises global positioning system signals.

4. The method of claim 1, further comprising:
determining a change in the estimated time of arrival; and
sending an update message to the communication device associated with the first destination location, the update message indicating the change in the estimated time of arrival.

5. The method of claim 4, further comprising determining that the change in the estimated time of arrival is greater than a threshold value.

6. The method of claim 1, further comprising prompting a user to specify one or more items intended to be purchased at the destination.

7. The method of claim 6, wherein the notification message further indicates the one or more items intended to be purchased at the destination.

8. The method of claim 7, further comprising receiving a status message in response to sending the notification message, the status message indicating one or more of:
an availability of the one or more items intended to be purchased;
sale information;
a coupon code; and
a second destination where the one or more items intended to be purchased are available.

9. The method of claim 1, further comprising sending a notification message to an alternate destination, the alternate destination comprising a competing destination of the first destination.

10. The method of claim 1, further comprising prompting a user with a list of one or more alternate destinations, the one or more alternate destinations comprising one or more competing destinations of the first destination.

11. The method of claim 1, further comprising:
selecting a second destination;
determining a location of the second destination;
calculating an estimated time of arrival for the mobile endpoint to arrive at the location of the second destination;
sending a notification message to a communication device associated with the second destination, the notification message comprising the estimated time of arrival; and
sending an update message to the communication device associated with the first location, the update message indicating a change in the estimated time of arrival.

12. The method of claim 1, wherein the notification message is anonymous with respect to an identity associated with the mobile endpoint.

13. The method of claim 1, further comprising receiving the notification message at a communication device associated with a destination location.

14. A method for communicating directions, comprising:
receiving an input comprising a product intended to be purchased;
sending a request message, the request message indicating the product intended to be purchased; and
receiving, from a first destination, availability information associated with the product intended to be purchased;
determining a location of the first destination; and
providing directions to the first destination.

15. The method of claim 14, wherein:
the product intended to be purchased is associated with a radio frequency identification number; and
the request message comprises the radio frequency identification number.

16. A system for communicating an arrival notification, comprising a mobile endpoint comprising:
a processor operable to:
determine a location of a first destination; and
calculate an estimated time of arrival, the estimated time of arrival indicating an estimated time for the mobile endpoint to arrive at the location of the first destination; and
an interface coupled to the processor and operable to send a notification message to a communication device associated with the first destination, the notification message indicating the estimated time of arrival.

17. The system of claim 16, wherein:
the interface is further operable to receive position information associated with the mobile endpoint; and
the processor is further operable to determine a position of the mobile endpoint from the position information.

18. The system of claim 17, wherein the position information comprises global positioning system signals.

19. The system of claim 16, wherein:
the processor is further operable to determine a change in the estimated time of arrival; and
the interface is further operable to send an update message to the communication device associated with the first destination location, the update message indicating the change in the estimated time of arrival.

20. The system of claim 19, wherein the processor is further operable to determine that the change in the estimated time of arrival is greater than a threshold value.

21. The system of claim 16, wherein the processor is further operable to prompt a user to specify one or more items intended to be purchased at the destination.

22. The system of claim 21, wherein the notification message further indicates the one or more items intended to be purchased at the destination.

23. The system of claim 22, wherein the interface is further operable to receive a status message in response to sending the notification message, the status message indicating one or more of:
an availability of the one or more items intended to be purchased;
sale information;
a coupon code; and
a second destination where the one or more items intended to be purchased are available.

24. The system of claim 16, wherein the interface is further operable to send a notification message to an alternate destination, the alternate destination comprising a competing destination of the first destination.

25. The system of claim 16, wherein the processor is further operable to prompt a user with a list of one or more alternate destinations, the one or more alternate destinations comprising one or more competing destinations of the first destination.

26. The system of claim 16, wherein, in response to a user selecting a second destination:
the processor is operable to:
determine a location of the second destination; and
calculate an estimated time of arrival for the mobile endpoint to arrive at the location of the second destination; and
the interface is operable to:
send a notification message to a communication device associated with the second destination, the notification message comprising the estimated time of arrival; and
send an update message to the communication device associated with the first location, the update message indicating a change in the estimated time of arrival.

27. The system of claim 16, wherein the notification message is anonymous with respect to an identity associated with the mobile endpoint.

28. A system for communicating directions, comprising a mobile endpoint comprising:
an interface operable to:
send a request message, the request message indicating a product intended to be purchased; and
receive, from a first destination, availability information associated with the product intended to be purchased; and
a processor operable to:
determine a location of the first destination; and
provide directions to the first destination.

29. The system of claim 28, wherein:
the product intended to be purchased is associated with a radio frequency identification number; and
the request message comprises the radio frequency identification number.

30. Logic embodied in a computer readable medium, the computer readable medium comprising code operable to:
determine a location of the first destination;
calculate an estimated time of arrival, the estimated time of arrival indicating an estimated time for the mobile endpoint to arrive at the location of the first destination; and
send a notification message to a communication device associated with the first destination, the notification message indicating the estimated time of arrival.

31. The logic of claim 30, wherein the code is further operable to:
receive position information associated with the mobile endpoint; and
determine a position of the mobile endpoint from the position information.

32. The logic of claim 31, wherein the position information comprises global positioning system signals.

33. The logic of claim 30, wherein the code is further operable to:
determine a change in the estimated time of arrival; and
send an update message to the communication device associated with the first destination location, the update message indicating the change in the estimated time of arrival.

34. The logic of claim 33, wherein the code is further operable to determine that the change in the estimated time of arrival is greater than a threshold value.

35. The logic of claim 30, wherein the code is further operable to prompt a user to specify one or more items intended to be purchased at the destination.

36. The logic of claim 35, wherein the notification message further indicates the one or more items intended to be purchased at the destination.

37. The logic of claim 36, wherein the code is further operable to receive a status message in response to sending the notification message, the status message indicating one or more of:
an availability of the one or more items intended to be purchased;
a coupon code;
sale information; and
a second destination where the one or more items intended to be purchased are available.

38. The logic of claim 30, wherein the code is further operable to send a notification message to an alternate destination, the alternate destination comprising a competing destination of the first destination.

39. The logic of claim 30, wherein the code is further operable to prompt a user with a list of one or more alternate destinations, the one or more alternate destinations comprising one or more competing destinations of the first destination.

40. The logic of claim 30, wherein, in response to a user selecting a second destination, the code is operable to:
determine a location of the second destination;
calculate an estimated time of arrival for the mobile endpoint to arrive at the location of the second destination;
send a notification message to a communication device associated with the second destination, the notification message comprising the estimated time of arrival; and
send an update message to the communication device associated with the first location, the update message indicating a change in the estimated time of arrival.

41. The logic of claim 30, wherein the notification message is anonymous with respect to an identity associated with the mobile endpoint.

42. Logic embodied in a computer readable medium, the computer readable medium comprising code operable to:
receive an input comprising a product intended to be purchased;
send a request message, the request message indicating the product intended to be purchased; and
receive, from a first destination, availability information associated with the product intended to be purchased;
determine a location of the first destination; and
provide directions to the first destination.

43. The logic of claim 42, wherein:
the product intended to be purchased is associated with a radio frequency identification number; and
the request message comprises the radio frequency identification number.

44. A system for communicating an arrival notification comprising:
means for determining a location of a first destination;
means for calculating an estimated time of arrival, the estimated time of arrival indicating a time for a mobile endpoint to arrive at the location of the first destination;
means for sending a notification message to a communication device associated with the first destination, the notification message indicating the estimated time of arrival; and
means for receiving the notification message at a communication device associated with the destination location.
